(19) United States
(12) Patent Application Publication
(10) Pub. No.: US 2025/0342574 A1
(43) Pub. Date: Nov. 6, 2025

(54) IMAGE BASED IDENTIFICATION SYSTEM AND RELATED METHODS FOR IDENTIFYING COLLECTIBLE ITEMS

(71) Applicant: Collectors Universe, Inc., Santa Ana, CA (US)

(72) Inventors: Pushkar Kumar Jain, Dallas, TX (US); Imir Kalkanci, Placentia, CA (US); Bradley Sliz, Libertyville, IL (US); David Shalamberidze, Naples, FL (US); Pratixa Joshi, Fremont, CA (US)

(73) Assignee: Collectors Universe, Inc., Santa Ana, CA (US)

(21) Appl. No.: 19/196,844

(22) Filed: May 2, 2025

Related U.S. Application Data
(60) Provisional application No. 63/642,093, filed on May 3, 2024.

(51) Int. Cl. G06T 7/00; G06F 16/583

(52) U.S. Cl. CPC G06T 7/0002; G06F 16/583

(57) ABSTRACT

A system for using machine learning to determine an identification of a collectible item has one or more computer devices having a computer processor and computer memory, the computer memory storing executable code that, when executed by the computer processor, enables the computer system to perform a process. The process includes receiving an image of the collectible item, and using machine learning to determine, from the image, an identification that may include, in some embodiments, a subject, a year of publication, and a manufacturer. In some embodiments, it may further include a parallel of the collectible item.

### CROSS-REFERENCE TO RELATED APPLICATIONS

This application for a utility patent claims the benefit of U.S. Provisional Application No. 63/642,093, filed May 3, 2024, the contents of which are expressly incorporated herein by reference.

### FIELD OF ART

The present disclosure is generally related to image-based identification systems for identifying collectible items, and more particularly to a system for using machine learning to identify a collectible item, and related methods. The present systems can be a standalone system or can be integrated into a larger system so that an output of the present system can be used for additional actions, such as to grade a collectible card.

### BACKGROUND

Collectible items come in many forms, including collectible trading cards, coins, sports cards, and stamps, to name a few non-limiting examples. Collectible items have long been collected by young and old alike. Some may collect collectible items for enjoyment, some may collect them in the hope for profit, and some may collect them for both. Knowledge about the collectible items can therefore be important to some. But even those who are collectors for mere enjoyment may also, from time to time, be curious about the items that they collected.

Unfortunately, it can be difficult to research and look up what the collector actually has in his or her possession. Having a tool or means to readily look up a collectible item is therefore desirable.

### SUMMARY

Aspects of the invention include a system for using machine learning to identify a collectible item. The identification of the collectible item is understood as information for uniquely identifying that particular collectible item, such as a card name and manufacturer code of that card. The system comprises one or more computer devices having a computer processor and computer memory, the computer memory storing executable code that, when executed by the computer processor, enables the computer system to perform a process comprising receiving an image of the collectible item, and using machine learning to determine, from the image, the identification, including, for example, a subject, a year of publication, a manufacturer, and a parallel of the collectible item, to name a few non-limiting examples.

### BRIEF DESCRIPTION OF THE DRAWINGS

These and other features and advantages of the present system and methods will become appreciated as the same becomes better understood with reference to the specification, claims and appended drawings.

FIG. 1 is a block diagram of one embodiment of a backend architecture that enables access to an inference service that embodies a system of the present invention.

FIG. 2 is a flow diagram of a prior art grading process.

FIG. 3 is a flow diagram of a grading process that incorporates an identification tool in accordance with aspects of the present invention.

FIG. 4 is a flow diagram of a training process for a machine learning model utilizing existing images.

FIG. 5 is a flow diagram of a process using the machine learning model trained in FIG. 4 for analyzing customer submitted images to determine an identification of the collectible item.

### DETAILED DESCRIPTION

The detailed description set forth below in connection with the appended drawings is intended as a description of the presently preferred embodiments of an identification system equipped with machine learning for analyzing spec properties, among other properties, of a collectible item provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

The system described herein may be implemented in a computer having a computer processor and a computer memory. For purposes of this application, the terms “computer,” “computer device,” “server,” and similar terms, refer to a device and/or system of devices that include at least one computer processor, and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “computer processor” as used herein refers to an electrical component that performs operations on an external data source, such as a computer memory, typically in the form of a microprocessor, although any equivalent structure may be used.

The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory include, for example, hard drives and other forms of magnetic media, optical media such as CD-ROM disks, as well as various forms of RAM, ROM, PROM, EPROM, FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The term “network” is defined to include any device or system for communicating information from one computer device to another. For example, a global computer network (e.g., the Internet) may be used, including any form of local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines, Digital Subscriber Lines (DSLs), wireless links including satellite links, or other communications links known to those skilled in the art. The network may further include any form of wireless network, including cellular systems, WLAN, Wireless Router (WR) mesh, or the like. Access technologies such as 3G, 4G, 5G, and future access networks may enable wide area coverage for mobile devices. In essence, the wireless network may include any wireless communication mechanism known in the art by which information may travel between computers of the present system.

The drawing figures described further hereinbelow illustrate aspects of the invention, which is directed to a system that uses machine learning for identifying the spec of a collectable item based at least in part on images of the collectible item. While the collectible item can be any number of items, such as a trading card, a baseball card, a memorabilia, a game card, a coin, a comic book, etc., for purposes of the present disclosure it can be a collectible trading card.

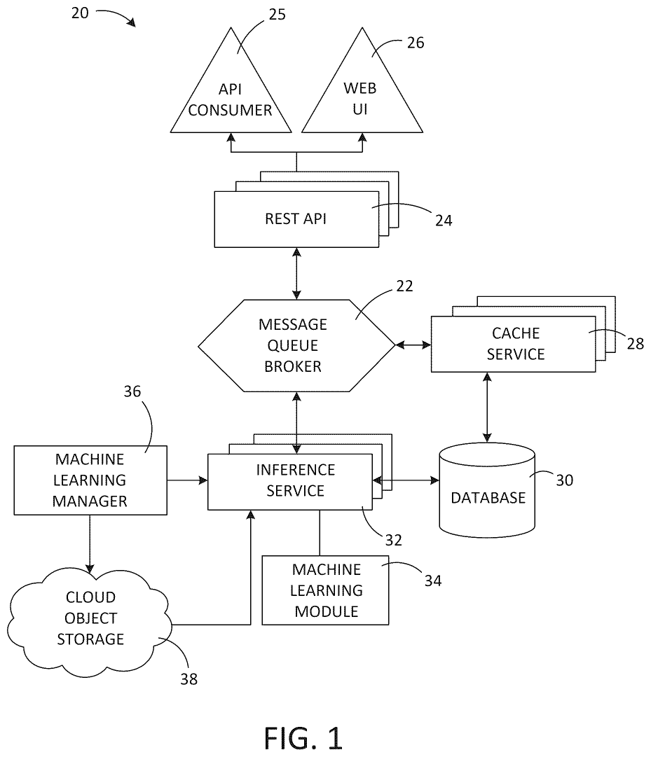

FIG. 1 is a block diagram of one embodiment of a backend architecture 20 that enables access to an inference service that embodies an identification system in accordance with aspects of the present invention. As shown in FIG. 1, the backend architecture 20 is based around a communication architecture such as a message queue broker 22, in this case an open source messaging system such as neural automatic transport service (“NATS”), although any form of message queue broker or equivalent system known in the art may be used. In this embodiment, the message queue broker 22 receives outside input via a REST API 24, which provides endpoints for direct interaction with the underlying system. The message queue broker 22 processes incoming requests and facilitates client-system communication. Requests and responses, in this embodiment, use JSON format, but other formats known in the art may be used to interact with consumer APIs 25, a web UI 26, and any other similar or equivalent systems. In this embodiment, NATS messaging is used for broadcasting notifications and receives results related to endpoint request activities.

The message queue broker 22 is also operably connected with a cache service 28 operably engaged with a database 30 that contains cached past predictions, so that the system can determine if the submission has already been received. The cache service 28 avoids wasted computations and improves data access by maintaining a cache of past predictions. The cache service fetches historical predictions from the database 30 but also maintains a time-controlled in-memory cache for more requests. The expiration of in-memory cache items may be, although this is not required, adjustable. The service updates the database 30 to flag items requiring model predictions. NATS messaging can be used for processing prediction requests and for updating the in-memory cache with real-time prediction data.

The message queue broker 22 is further operably connected with an inference system 32 that contains the machine learning model 34. This is discussed in greater detail below. The inference system 32 of this embodiment executes prediction tasks using a machine learning manager 36 in an isolated process, communicating with the parent service (e.g., via stdin, stdout, and stderr). The machine learning model manager 36, such as MLflow, or any equivalent model management facility, may be utilizing cloud object storage 38, such as Amazon® S3, or any equivalent system to store model and other artifacts. In this embodiment, the service interfaces with the machine learning lifecycle management server, MLFlow or equivalent model management facility, to receive model metadata, state, and artifacts of historical and the active model.

Part of this MLFlow orchestration also involves the service interacting with the cloud object storage, which serves as a storage location for model artifacts. Instance 0 of the stateful set, acting as a conductor, can synchronize model state information from MLFlow to the local database. The database can also be used as a centralized ledger of items from which this service reserves items awaiting model prediction. NATS messaging is used to disseminate prediction results and to also coordinate model change events across inference service instances.

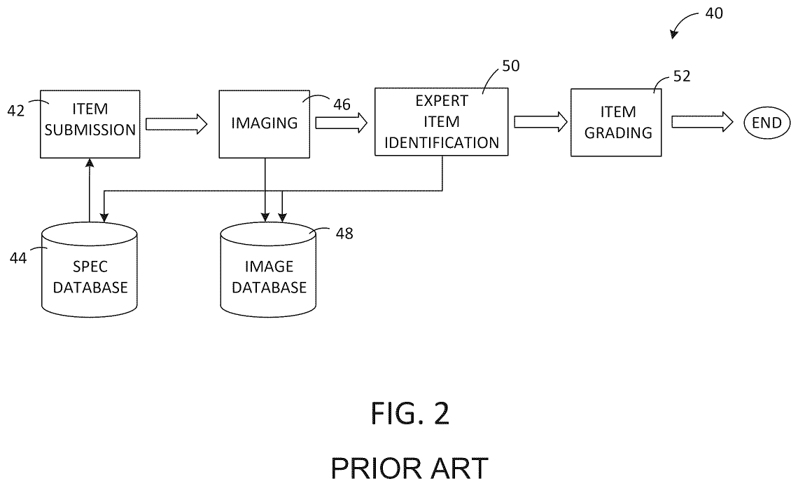

FIG. 2 is a flow diagram of an exemplary prior art grading process 40 for a collectible item. As shown in FIG. 2, at an item submission step 42 of the grading process 40, the collectible item is received and an imaging step 46 is performed to capture an image of the item (e.g., a collectible card). The image may be scanned or photographed or otherwise imaged by the user, or by the grading company, or it may be pulled from a database 44. The captured image may be stored in an image database 48. During the grading process 40, the image is sent for expert item identification 50, e.g., an expert grader reviews the item and determines its spec details. Once reviewed by the human grader, the item is sent to an item grading 52 step, which is also performed by the same or different grader. Due to reliance on a human grading expert, this prior art system is slow, inefficient, and expensive.

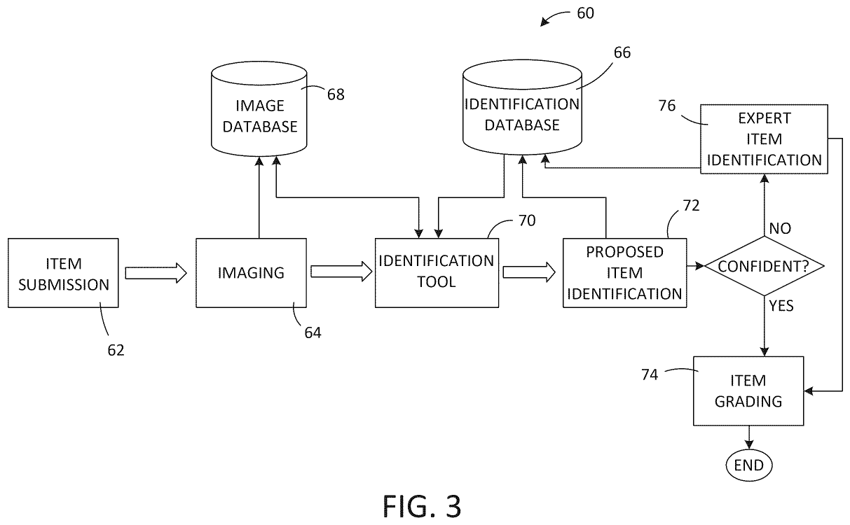

FIG. 3 is a flow diagram of an automated grading process 60, utilizing machine learning, that incorporates an identification tool 70 in accordance with aspects of the present invention. The identification tool 70 may be a part of the inference service 32 of FIG. 1. As shown in FIG. 3, at an item submission step 62 of the automated grading process 60, an item (e.g., a collectible card) is submitted and sent for imaging 64. In another embodiment, the customer might alternatively just submit an image directly, thereby removing the need to scan or otherwise capture an image of the item. The image of the item is then sent to an image database 68, which stores the image. The identification tool 70 receives the image and communicates with the image database 68 and the identification database 66 to identify the item.

For the purposes of this application, the term “spec” refers to a preset dataset of identifying information on the given collectible item/card. The preset dataset may include information such as year minted/published, subject (such as the name of an athlete, or similar), the manufacturer or brand name (e.g., FLEER™), the product line (e.g., “all-stars,” or a classification number), the color of the card, the rarity of the card, the serial number/ID number, or any other identifying information that can be implemented into the machine learning system in accordance with aspects of the invention.

In an example, the system then receives query images in the form of one or more images and sends the one or more images to the identification model (a trained model) to generate query embedding vectors. The query embedding vectors are compared to the identification embedding vectors to find similar vectors. Identification embedding vectors are generated for known collectible cards and contain attributes specific to the known cards.

Embedding vectors are understood as mathematical representations of objects, such as words, sentences, images, or other data, as points or vectors in a continuous, multi-dimensional space that can extend to hundreds or thousands of dimensions, typically as an array of numbers, such as [0.45, 0.33, −0.52, . . . , 0.92]. Discrete embedded vectors for images are mapped into a continuous vector space where similar things are closer together and different things are farther apart. Embedding vectors for one image, such as for an image in which the spec of that image is inquired about, can be used to compare them to embedding vectors of other images along the continuous vector space. The system can then return nearby mapped vectors as potential match of the image inquired about. The system can be trained to only return a range of closely mapped vectors or points or only identical embedded vectors, depending on the confidence set points established for the system. In some examples, the embedding vectors of the inquired image can be added to the system's indexed database as additional embedded vectors that are mapped by the system.

The machine learning model checks to see if the query embedding vectors for the collectible card to be identified are sufficiently similar to the identification embedding vectors to within a defined or predetermined threshold. Threshold values can be calculated and experimented with to “fine tune” the process to obtain optimal performance. If the threshold cannot be reached, the system then checks if the use case requires an exact match. If an exact match is required, then the system concludes that there is no match, and a no match report is returned. If an exact match is not required, such as when the compared vectors are within a predetermined threshold, then the top number (N) of similar identifications as for the collectible card to be determined are returned to the end user so that the end user is able to select the correct identification match from one of several predicted identifications returned by the system. In an example, N can represent three to six predicted identification matches that can be presented to the end user to select from. In other examples, the number can vary. When the threshold is close exact, N can be a smaller number, such as one or two.

In another embodiment, the machine learning model is trained to predict and return top N number of similar identifications or matches. In an example, N can represent three to six predicted identification matches that can be presented to the end user to select from. In other examples, the number of matches presented to the user can vary, such as two or more than six. Additionally, users can set predetermined threshold values to obtain optimal performance. The threshold values can be calculated and experimented with to “fine tune” the process, which can affect the number of similar identifications or matches.

At a next step of the process 60, the identification tool 70 then creates a proposed item identification 72 for the inquired collectible item or image, which is then stored in the database 66. As the system has identified a new image and has stored that information for future use, the process can end. In some examples, if the identification tool 70 is confident with the item identification, output of that information may be integrated in additional processes. For example, the item may then be utilized in a grading process, such as by using machine learning to assign a grade to the identified collectible item. As shown, the item is sent for item grading 74 to complete a grading process 60. However, if the identification tool 70 is not confident that the proposed item identification is accurate, an expert item identification step 76 can include an expert (i.e., a human grader) for checking the proposed identification, cross-referencing the identification database 66, and determining a confident item identification for grading 74.

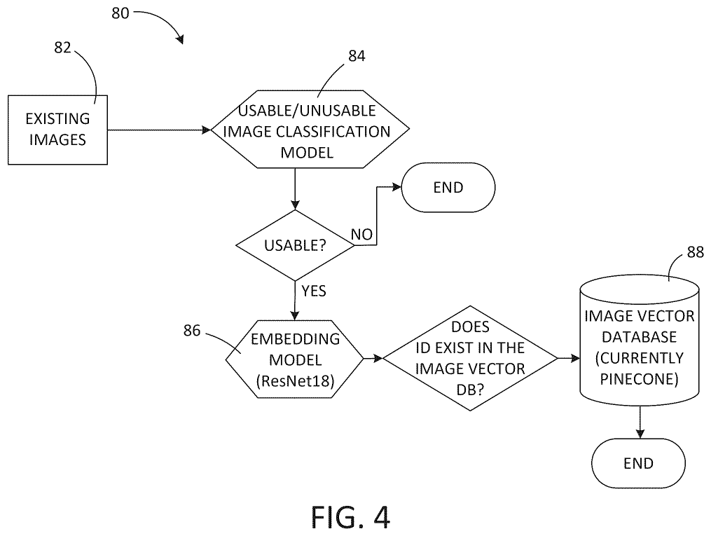

FIG. 4 is a flow diagram of a training process 80 that may be used as part of training a machine learning model utilizing existing known identification images. As shown in FIG. 4, the training process 80 comprises the steps of first receiving existing identification image(s) 82 and transferring them into an image classification model 84 that determines whether each image is usable. If the image is not usable, the system may simply end, but in alternative embodiments, other steps may be incorporated to either attempt to repair or otherwise fix the image, or to replace it with a suitable image. In yet another alternative embodiment, the inferior image may still be used by the system even if to generate a lower confident result.

Once a usable image is available, the image is sent to an embedding model 86, which is used to determine if the identification (spec) exists in an image vector database 88, and adding the identification if it does not already exist in the database 88. The embedding model 86 transfers the embedded data to the image vector database 88, which may be in the form of Pinecone or equivalent database. If the system is not able to find a similar image, such as not able to locate a record of a card that is in the same format as the inputted image, then the image may be processed through a manual review step, wherein a new identity can be created in the database for future training upon being manually identified by the human grader. This process can be performed repeatedly or over a large number of times so that the model 86 becomes increasingly accurate and the database fully formed. If the identification spec for the image under review already exists in the image vector database, and the identification embedding vectors are identical as the ones already in the database, then the duplicate information can be discarded. But if the identification embedding vectors are not exact, then the data can be added to the image vector database to increase the number of data points in the database.

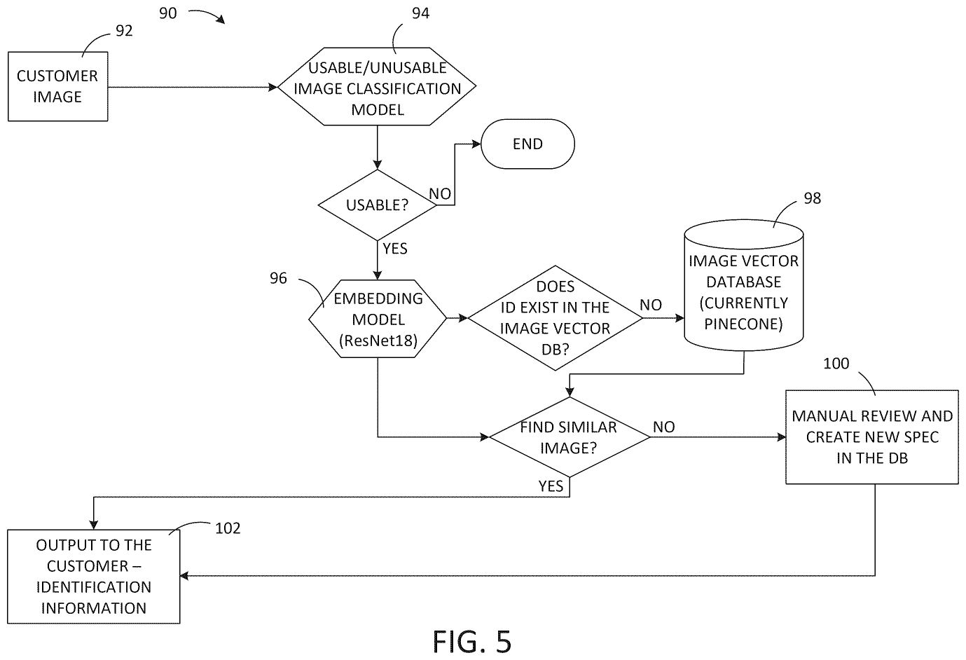

FIG. 5 is a flow diagram of a process 90 wherein the trained model of FIG. 4 is used to analyze customer submitted images 92 to determine information for each customer's submitted image. As illustrated in FIG. 5, the process 90 comprises the steps of first receiving the submitted customer image 90 into an image classification model 94 for determining whether the customer submitted image is usable. If the image is not usable, the process may end, or, as noted above, steps may be taken to obtain a usable image, or to repair the image.

The image is then sent to the embedding model 96 for analysis. The embedding model 96, with reference to the image vector database 98, attempts to find a similar image. If the system 90 is not able to find a similar image, the image may be processed through a step of manual review 100, wherein a new identification is created in the image vector database 98 for future reference. Once the new identification is created, or if a similar image is located, a determined identification of the customer submitted image 92 is output to the customer in a final step 102 of the process 90. Said differently, where the image is irrecoverable or unusable, the image can still be sent to the embedding model and the vector database can attempt to find a similar image albeit with possibly a lower confidence. Thus, the system is structured to utilize a range of images that can span between good quality images to poor quality images by involving both machine learning and human intervention. In some examples, similar images can be obtained by additionally leveraging other data such as textual descriptions or metadata.

The title of the present application, and the claims presented, do not limit what may be claimed in the future, based upon and supported by the present application. Furthermore, any features shown in any of the drawings may be combined with any features from any other drawings to form an invention which may be claimed. For example, the system is not limited to using a single image to find similar images. Indeed, in some examples, the system can be extended to consider multiple images of the same card to obtain accurate results.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention. Methods of using the above-described system and components thereof are within the scope of the present invention. Although limited embodiments of the system and their components have been specifically described and illustrated herein, many modifications and variations will be apparent to those skilled in the art. Furthermore, it is understood and contemplated that features specifically discussed for one embodiment may be adopted for inclusion with another embodiments, provided the functions are compatible. The disclosure is also defined in the following claims.

### Example Embodiments

The following are numbered example embodiments of methods, systems, and devices involving a collectible identification device or system that broadly comprises a machine learning- based inference engine, an image vector comparison module, and a database for storing collectible item specifications. The following examples, or any other examples disclosed herein, may be combined in whole or in part unless indicated otherwise. Elements of the examples disclosed herein, if applicable, are not limiting.

Example 1. A system comprising a server configured to receive an uploaded image of a trading card from a user device, wherein the system generates embedding vectors of the image, compares the embedding vectors of the uploaded image to an indexed database of embedding vectors for stored images, such as images of collectible cards, and identifies the card by determining the closest vector match, which embedded points can include mapped points for a card's manufacturer, year printed, subject represented by the image, and rarity of the card.

Example 2. A method comprising receiving multiple images of a collectible item such as a coin; normalizing and preprocessing the images; generating a unified embedding representation; comparing the representation to known coin vectors stored in a database; and outputting the top five most similar results along with confidence scores to a user interface.

Example 3. A computer-readable medium storing instructions that, when executed by a processor, cause the system to: access an image database of graded collectable items, such as comic book covers or collectible cards, apply a machine learning model to generate vector embeddings, determine if a user-submitted image of the comic book cover or collectible card, exceeds a similarity threshold to existing entries, and return a match result with metadata including issue number and publisher.

Example 4. A machine learning identification engine comprising: a cache layer for storing recent prediction results; an interface to an MLFlow model registry for managing active and historic versions of trained models; and an integration layer that allows prediction results to be forwarded directly to a grading workflow engine without user intervention.

Example 5. A system that identifies a collectible card, such as a sports card or a collectible card, using a backend inference service, wherein the inference service processes image inputs, determines whether a card has been previously submitted using a cache check, and returns a stored prediction if found, or generates a new prediction if not.

Example 6. A process for training an identification model, the process comprising: receiving a corpus of labeled images of collectible items; filtering and validating image quality; embedding each validated image into high-dimensional vectors or mapped points; checking for existing similar vectors in a Pinecone vector database; and flagging any unmatched vectors for manual classification and database insertion.

Example 7. A collectible card identification system deployed on a cloud architecture that includes: (i) a web interface for receiving user-submitted images, (ii) a backend inference pipeline with GPU support, (iii) a NoSQL database for storing metadata and predictions, and (iv) an administrative console that enables human graders to verify or override low-confidence predictions.

Example 8. The assembly, system, device, apparatus, and method of any of the above Examples alone or in combination, wherein the identification system is part of a price estimating system, as described in application Ser. No. 19/065,664, filed Feb. 27, 2025, the contents of which are expressly incorporated herein by reference.

Example 9. The assembly, system, device, apparatus, and method of any of the above Examples alone or in combination, wherein the identification system is part of a digital grading system, as described in U.S. Utility application Ser. No. 19/077,541, filed Mar. 12, 2025, the contents of which are expressly incorporated herein by reference. The disclosed grading system provides a grade for a collectible item based on, among other things, the card's centeredness.

Example 10. The assembly, system, device, apparatus, and method of any of the above Examples alone or in combination, wherein the identification system is part of a digital grading system, as described in U.S. Utility application Ser. No. 19/065,694, filed Feb. 27, 2025, the contents of which are expressly incorporated herein by reference. The disclosed grading system provides a grade for a collectible item based on, among other things, whether the collectible card is a counterfeit.

Example 11. The assembly, system, device, apparatus, and method of any of the above Examples alone or in combination, wherein the image for which spec information, such as the subject, the date, the rarity, is requested is sent or uploaded directly from the requester to the identification system.

Example 12. The assembly, system, device, apparatus, and method of any of the above Examples alone or in combination, wherein the image for which spec information, such as the subject, the date, the rarity, is requested is generated by a grading entity after the collectible is sent into the grading entity.

Example 13. The assembly, system, device, apparatus, and method of any of the above Examples alone or in combination, wherein the spec information is a preset dataset of identifying information on a given collectible item, and wherein the preset dataset include one or more of the following information: year minted/published, subject (such as the name of an athlete, or similar), the manufacturer or brand name (e.g., FLEER™), the product line (e.g., “all-stars,” or a classification number), the color of the card, the rarity of the card, the serial number/ID number, or any other identifying information that can be implemented into the machine learning system.

Example 14. The assembly, system, device, apparatus, and method of any of the above Examples alone or in combination, wherein an exact match between the embedding vectors of an image for which spec information is requested is not required, and wherein the identification system returns the top number (N) of similar identifications, in terms of closeness of embedded vectors or points.

Example 15. The assembly, system, device, apparatus, and method of any of the above Examples alone or in combination, wherein N can represent three or more predicted identification matches that can be presented to the end user to select from.

Example 16. The assembly, system, device, apparatus, and method of any of the above Examples alone or in combination, wherein N can represent less than eight predicted identification matches that can be presented to the end user to select from.

Example 17. The assembly, system, device, apparatus, and method of any of the above Examples alone or in combination, wherein the identification system returns the top number (N) of similar identifications and add the embedding vectors of the image for which spec information is requested into the system database.

Example 18. The assembly, system, device, apparatus, and method of any of the above Examples alone or in combination, wherein the identification system returns the top number (N) of similar identifications and returns a grade of 1 to 10.

Example 19. The assembly, system, device, apparatus, and method of any of the above Examples alone or in combination, wherein the identification system alerts a human to provide a manual input before returning the top number (N) of similar identifications.

Example 20. The assembly, system, device, apparatus, and method of any of the above Examples alone or in combination, wherein the identification system alerts a human to provide a manual input before returning a grade.

Example 21. The assembly, system, device, apparatus, and method of any of the above Examples alone or in combination, wherein the identification system returns a zero match for the image for which spec information is requested, indicating that the image is not usable.

Example 22. The assembly, system, device, apparatus, and method of any of the above Examples alone or in combination, wherein the identification system alerts a human to repair the image for which spec information is requested, replace the image with a similar but usable image, or manually identify the spec information.

What is claimed is:

1. A system for using machine learning to determine an identification of a collectible item, the system comprising:
one or more computer devices having a computer processor and computer memory, the computer memory storing executable code that, when executed by the computer processor, enables the computer system to perform a process that comprises:
receiving an image of the collectible item; and
using machine learning to determine, from the image, an identification that includes a subject, a year of publication, a manufacturer, and a parallel of the collectible item.

2. The system of claim 1, wherein the system first determines a proposed item identification with a confidence rating, and if the confidence rating is below a predetermined threshold, the proposed item identification is reviewed by a human expert who can validate or replace the proposed item identification.

3. A system for identifying a collectible item based on an image, the system comprising:
one or more computer devices having a computer processor and computer memory, the computer memory storing executable code that, when executed by the computer processor, enables the system to provide the following:
an image input interface configured to receive at least one image of a collectible item;
a machine learning identification model stored in the memory and executable by the processor, the model configured to:
i. generate an embedding vector from the image,
ii. compare the embedding vector to vectors stored in an image vector database, and
iii. output an identification of the collectible item based on similarity of the embedding vector to stored vectors;
a database storing previously identified collectible items and corresponding embedding vectors; and
an output interface configured to transmit the identification result to a user or a subsequent grading module.

4. The system of claim 3, wherein the identification comprises at least a year of publication, a manufacturer, a subject of the collectible item, and a product line classification.

5. The system of claim 3, wherein the output interface is further configured to send the identification result to an automated grading module.

6. The system of claim 3, wherein the image input interface is configured to receive a plurality of images of the same collectible item and aggregate results to improve identification confidence.

7. The system of claim 3, wherein the machine learning identification model is configured to return a set of N most similar matches when a confidence threshold is not exceeded.

8. The system of claim 3, further comprising a cache service configured to store prior identification results to reduce redundant computations.

9. The system of claim 3, further comprising a manual override module configured to allow expert review and confirmation of the identification.

10. The system of claim 3, wherein the machine learning model is integrated with a model lifecycle management system and utilizes cloud storage for model artifacts.

11. A method for identifying a collectible item using image-based machine learning, the method comprising:
receiving at least one image of a collectible item from a user device;
generating an embedding vector of the image using a trained machine learning model;
comparing the embedding vector to a plurality of reference vectors in an image vector database;
determining whether the similarity exceeds a predefined confidence threshold; and
outputting an identification result based on the comparison.

12. The method of claim 11, further comprising, if the similarity does not exceed the confidence threshold, returning a ranked list of likely identification results to the user.

13. The method of claim 11, further comprising storing the identified collectible item in a database for use in future queries.

14. The method of claim 11, further comprising integrating the identification result into an automated grading system for grading the collectible item.
